(19) United States
(12) Patent Application Publication
(10) Pub. No.: US 2018/0367983 A1
(43) Pub. Date: Dec. 20, 2018

(54) METHOD, SYSTEM AND SMART TERMINAL FOR IMPLEMENTING VIRTUAL SIM CARD

(71) Applicant: HUIZHOU TCL MOBILE COMMUNICATION CO., LTD, HUI ZHOU (CN)

(72) Inventors: XIANGHUI LOU, HUI ZHOU (CN); HAI CAI, HUI ZHOU (CN)

(21) Appl. No.: 15/771,237

(22) PCT Filed: Dec. 2, 2016
(86) PCT No.: PCT/CN2016/108368

§ 371 Date: Apr. 27, 2018

(30) Foreign Application Priority Data
May 3, 2016 (CN) 201610283076.9

(51) Int. Cl. H04W 8/18; H04W 8/20; H04L 29/06; H04W 12/06; H04W 88/06

(52) U.S. Cl. CPC H04W 8/183; H04W 8/20; H04W 88/06; H04W 12/06; H04L 63/0876

(57) ABSTRACT

A virtual SIM card can establish a communication connection between a subscriber terminal and a virtual SIM card operation server, sending order information for purchasing the virtual SIM card to the virtual SIM card operation server, receiving IMSI and authentication information of a virtual SIM card corresponding to the order information returned by the virtual SIM card operation server, downloading said IMSI and authentication information locally and activating a preset virtual SIM card module, and controlling the virtual SIM card module to access the network via a MODEM port module.

### FIELD OF THE INVENTION

The present invention relates to the field of wireless communication technologies, and in particular to a method, system and smart terminal for implementing a virtual SIM card.

### DESCRIPTION OF THE RELATED ART

Conventional SIM cards are physical SIM cards, which are typically disposed in terminals for use. A terminal reads information from a physical SIM card and performs relevant authentication. When authentication is passed, normal communications can be conducted. A physical SIM card can only be embedded into a terminal and bundled to a terminal. Once the physical SIM card is lost, the subscriber may not be able to perform communications. Therefore, subscribers may be absolutely dependent on physical SIM cards, which results in tremendous inconvenience for the subscribers. Along with the social and economic development, moreover, the number of Chinese people going overseas for tours and businesses has increased sharply. When going abroad, more and more people use cell phones to access the Internet. However, the international roaming services are very expensive. To avoid the expensive international roaming fee, subscribers either look for free WIFI or purchase local SIM cards. However, free WIFI is only available at some fixed locations, and it is relatively troublesome to buy local cards as replacement. As a result, it is very inconvenient for the subscribers to live abroad. Therefore, the prior art needs to be further improved.

### SUMMARY OF THE INVENTION

The present invention provides a method, system and smart terminal for implementing a virtual SIM card, so as to address the defects that a real SIM card of a smart terminal according to the prior art has authentication for fixed regions, and that a subscriber needs to pay for relatively high roaming fees or the subscriber may need to replace a SIM card with a local SIM card for use in other countries.

The present invention provides a method for implementing a virtual SIM card, comprising:

establishing communication connection between a subscriber terminal and a virtual SIM card operation server;

returning to the subscriber terminal, by the virtual SIM card operation server according to received order information of the subscriber terminal for purchasing a virtual SIM card, IMSI and authentication information of a virtual SIM card corresponding to the received order information;

the subscriber terminal downloading the IMSI and authentication information returned by the virtual SIM card operation server locally and activating a preset virtual SIM card module according to the IMSI and authentication information; and

establishing connection between the virtual SIM card module and a MODEM port module, wherein the MODEM port module accesses a network by reading the IMSI and authentication information in the virtual SIM card module.

In an embodiment, before the establishing communication connection between a subscriber terminal and the virtual SIM card operation server, the method may further comprise: creating the virtual SIM card module in a memory of the subscriber terminal, wherein said virtual SIM card module is configured to store the IMSI and authentication information downloaded from the virtual SIM card operation server.

In an embodiment, the returning to the subscriber terminal, by the virtual SIM card operation server according to the received order information of the subscriber terminal for purchasing a virtual SIM card, IMSI and authentication information of a virtual SIM card corresponding to the order information may further comprise:

the subscriber terminal submitting purchase orders of virtual SIM cards selected by the subscriber to the virtual SIM card operation server; and

the virtual SIM card operation server performing one-to-one bundling of the purchase orders and IMSIs of corresponding virtual SIM cards according to the purchase orders.

In an embodiment, the activating a preset virtual SIM card module according to the IMSI and authentication information may further comprise:

the subscriber terminal updating SIM card information stored in the virtual SIM card module according to the IMSI and authentication information returned by the virtual SIM card operation server.

In an embodiment, the activating the preset virtual SIM card module according to the IMSI and authentication information further comprises: determining whether a SIM card activation mode supported by the MODEM port module is a single-card mode or a dual-card mode.

In an embodiment, the establishing connection between the virtual SIM card module and the MODEM port module may comprise:

when it is determined that the SIM card activation mode supported by the MODEM port module is a single-card mode and a signal to activate the virtual SIM card module is received, establishing communication connection between the virtual SIM card module and the MODEM port module;

when it is determined that the SIM card activation mode supported by the MODEM port module is a dual-card mode and the signal to activate the virtual SIM card module is received, establishing communication connection in which a valid real SIM card module and the virtual SIM card module are both connected to the MODEM port module.

In an embodiment, a type of the real SIM card module comprises single card type or dual card type and the “when it is determined that the SIM card activation mode supported by the MODEM port module is a dual-card mode and a signal to activate the virtual SIM card module is received, establishing communication connection in which a valid real SIM card module and the virtual SIM card module are both connected to the MODEM port module” may comprise:

when the type of the real SIM card module is the single card type, controlling two ports of the MODEM port module to connect to the real SIM card module of the single card type and the virtual SIM card module;

when the type of the real SIM card module is the dual card type, controlling two ports of the MODEM port module to connect to any real SIM card in the real SIM card module of the dual card type and the virtual SIM card module.

In an embodiment, after controlling two ports of the MODEM port module to connect to the real SIM card module of the single card type and the virtual SIM card module, the method may further comprise:

upon receiving a signal to shut down the virtual SIM card module, controlling the real SIM card module of the single card type to maintain a normal working state and controlling the virtual SIM card module to exit the normal working state.

In an embodiment, after controlling two ports of the MODEM port module to connect to any real SIM card in the real SIM card module of the dual card type and the virtual SIM card module, the method may further comprise:

upon receiving a signal to shut down the virtual SIM card module, controlling all real SIM cards in the real SIM card module of the dual card type to recover to the normal working state and controlling the virtual SIM card module to exit the normal working state.

In an embodiment, the use priority of the virtual SIM card module is higher than the use priority of the real SIM card module.

The present invention may further provide a system for implementing a virtual SIM card, comprising:

a communication establishing module configured to establish communication connection between a subscriber terminal and a virtual SIM card operation server;

a virtual card order module configured for the virtual SIM card operation server to return, according to received order information of the subscriber terminal for purchasing a virtual SIM card, IMSI and authentication information of a virtual SIM card corresponding to the received order information of the subscriber terminal;

a virtual card activating module configured for the subscriber terminal to download the IMSI and authentication information returned by the virtual SIM card operation server locally and activate a preset virtual SIM card module according to the IMSI and authentication information; and

a virtual card accessing module configured to establish connection between the virtual SIM card module and a MODEM port module, wherein the MODEM port module accesses a network by reading the IMSI and authentication information in the virtual SIM card module.

In an embodiment, the system further comprises: a virtual card presetting module configured to create a virtual SIM card module in a memory of the subscriber terminal; said virtual SIM card module being configured to store the IMSI and authentication information downloaded from the virtual SIM card operation server.

In an embodiment, the virtual card order module may further comprise: an order submitting unit configured for the subscriber terminal to submit purchase orders of virtual SIM cards selected by the subscriber to the virtual SIM card operation server; and

an information bundling unit configured for the virtual SIM card operation server to perform one-to-one bundling of the purchase orders and IMSIs of corresponding virtual SIM cards according to the received purchase orders.

In an embodiment, the virtual card activating module may further comprise: an information updating unit configured for the subscriber terminal to update the SIM card information stored in the virtual SIM card module according to the IMSI and authentication information returned by the virtual SIM card operation server.

In an embodiment, the virtual card activating module may further comprise: a mode determining unit configured to determine whether the SIM card activation mode supported by the MODEM port module is a single-card mode or a dual-card mode.

In an embodiment, the virtual card accessing module may comprise: a single-card connecting unit configured to, when it is determined that the SIM card activation mode supported by the MODEM port module is a single-card mode and a signal to activate the virtual SIM card module is received, establish communication connection between the virtual SIM card module and the MODEM port module;

a dual-card connecting unit configured to, when it is determined that the SIM card activation mode supported by the MODEM port module is a dual-card mode and the signal to activate the virtual SIM card module is received, establish communication connection in which a valid real SIM card module and the virtual SIM card module are both connected to the MODEM port module.

In an embodiment, the type of the real SIM card module comprises single card type or dual card type, and the dual-card connecting unit may further comprise:

a first dual-card connecting unit configured to, when the type of the real SIM card module is the single card type, control two ports of the MODEM port module to connect to the real SIM card module of the single card type and the virtual SIM card module;

a second dual-card connecting unit configured to, when the type of the real SIM card module is the dual card type, control two ports of the MODEM port module to connect to any real SIM card in the real SIM card module of the dual card type and the virtual SIM card module.

In an embodiment, the first dual-card connecting unit may be further configured to, upon receiving a signal to shut down the virtual SIM card module, control the real SIM card module of the single card type to maintain a normal working state and control the virtual SIM card module to exit the normal working state; the second dual-card connecting unit may be further configured to, upon receiving a signal to shut down the virtual SIM card module, control the real SIM card module of the single card type to maintain the normal working state and control the virtual SIM card module to exit the normal working state.

In an embodiment, a smart terminal, may comprise: one or more processors; a memory, and one or more programs, wherein said one or more programs are stored in the memory and configured to be executed by said processors, wherein said one or more processors are configured to execute the following instructions:

establishing communication connection between a subscriber terminal and a virtual SIM card operation server;

returning, by the virtual SIM card operation server according to received order information of the subscriber terminal for purchasing a virtual SIM card, IMSI and authentication information of a virtual SIM card corresponding to the received order information of the subscriber terminal;

the subscriber terminal downloading the IMSI and authentication information returned by the virtual SIM card operation server locally and activating a preset virtual SIM card module according to the IMSI and authentication information; and

establishing connection between the virtual SIM card module and a MODEM port module, wherein the MODEM port module accesses a network by reading the IMSI and authentication information in the virtual SIM card module.

In an embodiment, before being configured to establish communication connection between a subscriber terminal and the virtual SIM card operation server, said one or more processors are further configured to execute the following instructions:

creating the virtual SIM card module in the memory of the subscriber terminal, wherein said virtual SIM card module is configured to store the IMSI and authentication information downloaded from the virtual SIM card operation server.

By establishing communication connection between the subscriber terminal and the virtual SIM card operation server, the smart terminal sends order information for purchasing a virtual SIM card to the virtual SIM card operation server, receives IMSI and authentication information of a virtual SIM card corresponding to the order information returned by the virtual SIM card operation server, downloads said IMSI and authentication information returned by the virtual SIM card operation server locally, activates a preset virtual SIM card module according to the IMSI and authentication information, and controls the virtual SIM card module to access a network via a MODEM port module. A subscriber can select different roaming packages according to the type of the SIM card in his/her own cell phone, and can conveniently access the Internet, which not only avoids the trouble to look for free WIFI or replace with a local SIM card, but also can avoid high roaming expenses due to the use of a domestic network in other countries or a different location.

### BRIEF DESCRIPTION OF THE DRAWINGS

FIG. 1 is a flow chart of the steps of a method for implementing a virtual SIM card according to an embodiment of the present invention.

FIG. 2 is a flow chart of the steps in a specific embodiment of a method for implementing a virtual SIM card according to an embodiment of the present invention.

FIG. 3 is a schematic diagram of a mode of single-card cell phone and single-card modem port in an embodiment of the method according to the present invention.

FIG. 4 is a schematic diagram of a mode of a single-card cell phone and a dual-card modem port in an embodiment of the method according to the present invention.

FIG. 5 is a schematic diagram of a mode of a dual-card cell phone and a dual-card modem port in an embodiment of the method according to the present invention.

FIG. 6 is a structural block diagram of a system for implementing a virtual SIM card according to the present invention.

FIG. 7 is a schematic diagram of the structure of a terminal according to the present invention.

### DETAILED DESCRIPTION OF THE INVENTION

To make objects, technical solutions and advantages of the present invention clearer and more specific, the present invention will be further described in detail below with reference to the accompanying drawings and embodiments. It should be understood that the specific embodiments described herein are only used to explain the present invention, instead of limiting the present invention.

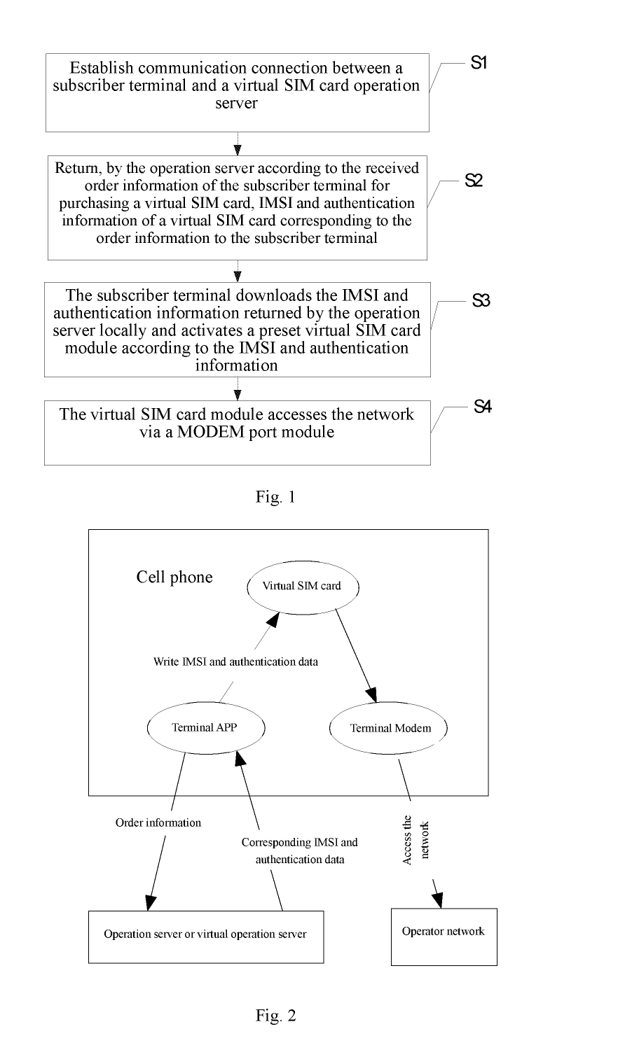

The present invention provides a method for implementing a virtual SIM card, as shown in FIG. 1, and may comprise:

S1. Establishing a communication connection between a subscriber terminal and a virtual SIM card operation server.

Since it may be necessary to purchase information of a virtual SIM card, such as IMSI and authentication data, from the virtual SIM card operation server, the communication connection may need to be established first between a subscriber terminal and the virtual SIM card operation server so as to establish information interaction between the two, such that the subscriber terminal can obtain corresponding virtual SIM card information.

The above communication connection may be either wired connection or wireless connection via either a mobile network produced by a real SIM card of the subscriber terminal or a wireless WIFI network, as long as information interaction can be established between the two.

S2. Returning to the subscriber terminal, by the virtual SIM card operation server according to the received order information of the subscriber terminal for purchasing a virtual SIM card, IMSI and authentication information of a virtual SIM card corresponding to the received order information.

The subscriber terminal can send the information of its purchase of a virtual SIM card to the virtual SIM card operation server, and then the virtual SIM card operation server can issue IMSI and authentication information of a virtual SIM card corresponding to the order information to the subscriber terminal. In a specific implementation, a terminal APP may be developed in the subscriber terminal that is used to monitor subscriber information, subscriber purchase orders, purchase order status, and purchase order use situation, so as to realize interaction between the subscriber terminal and the virtual SIM card operation server and facilitate the use by the subscriber.

The subscriber may first open said terminal APP, register, log on, and select a desired SIM card according to numbers and other information of virtual SIM cards pushed by the terminal APP, such as use fees, corresponding region and the like. The subscriber then can send the confirmed order information of the selected virtual SIM card to the virtual SIM card operation server, and the virtual SIM card operation server can analyze the received order and issues information of a virtual SIM card corresponding to the order for sending to the subscriber terminal.

S3. The subscriber terminal can download the IMSI and authentication information returned by the virtual SIM card operation server locally and activate a preset virtual SIM card module according to the IMSI and authentication information.

The subscriber terminal can download the data and information of the virtual SIM card returned by the virtual SIM card operation server locally, and activate a corresponding local virtual SIM card module according to the obtained data.

S4. The virtual SIM card module can access the network via a MODEM port module.

Although the virtual SIM card module can be implemented through software, it has the same functions as those of a real SIM card, which not only comprises functions for storing SIM card related files and information, but also has a communication port for connection with a MODEM and accessing a network.

To implement the use of the virtual SIM card of the subscriber terminal, before the step S1, the method may further comprise:

S01. Creating a virtual SIM card module in a memory of the subscriber terminal, wherein said virtual SIM card module is configured to store the IMSI and authentication information downloaded from the virtual SIM card operation server.

To smoothly select a desired virtual SIM card, the step S2 may further comprise:

S211. The subscriber terminal submitting purchase orders of virtual SIM cards selected by the subscriber to the virtual SIM card operation server.

S212. The virtual SIM card operation server performing one-to-one bundling of the purchase orders and IMSIs of corresponding virtual SIM cards according to the purchase orders.

When a subscriber purchases a roaming package in the terminal APP, the virtual SIM card operation server can complete a bundling relationship between the subscriber and the order, and the MODEM port module can access the network according to the IMSI and authentication data corresponding to the bundling relationship, and each subscriber and order form a unique IMSI.

In an embodiment, a subscriber terminal can implement selection, confirmation and submittal of a purchase order through the terminal APP. Upon receiving the purchase order, the virtual SIM card operation server can issue, according to the type of the virtual SIM card purchased in the order, the corresponding virtual SIM card information to the subscriber terminal.

During use, a subscriber may need virtual SIM cards for different regions according to different locations where he/she is at. Therefore, the step S3 may further comprise:

S311. The subscriber terminal can update the SIM card information stored in the virtual SIM card module according to the IMSI and authentication information returned by the virtual SIM card operation server.

As different cell phone modes or MODEM port modes may have a variety of application modes, the step S3 may further comprise S321, and the step S4 may further comprise S411 and S412:

S321. Determine whether the SIM card activation mode supported by the MODEM port module is a single-card mode or a dual-card mode. If it is a single-card mode, go to the step S411; otherwise, go to the step S412;

S411. When a signal to activate the virtual SIM card module is received, establish communication connection between the virtual SIM card module and the MODEM port module;

S412. When a signal to activate the virtual SIM card module is received, establish communication connection in which a valid real SIM card module and the virtual SIM card module are both connected to the MODEM port module.

To describe the method according to the present invention in greater detail, as shown in FIG. 2, an embodiment of the present invention is used as an example.

A subscriber can purchase a roaming package through the terminal APP, while the virtual SIM card operation server completes a bundling relationship between the subscriber and the order. When the order is successfully activated, the virtual SIM card operation server can send IMSI and corresponding authentication data to the virtual SIM card through the terminal APP. When the virtual SIM card is activated, the virtual SIM card module can access the network via the MODEM port module.

Before the step S1, the method can further comprise: the subscriber downloading a terminal APP of the virtual SIM card roaming service, which may be equivalent to a terminal APP of online offices of the telecommunication companies like China Mobile, China Unicom or China Telecom.

When downloading is completed, the subscriber can enter the terminal APP and register to become a member of the terminal APP of the virtual SIM card roaming service. An operation server or the virtual SIM card operation server monitors actions of member subscribers.

If the virtual SIM card operation server detects that a member subscriber continues to perform other operations on the terminal APP, it may continue the monitoring; if the virtual SIM card operation server detects that the member subscriber is ready to exit, then the operation server or the virtual SIM card operation server saves the personal information of the registered member. The subscriber information includes subscriber account related operations, such as subscriber registration, logon, logout, and password revision. The member subscriber browses roaming package information on the terminal APP, and makes selections according to his/her own needs. After the subscriber selects a corresponding roaming package, submits an order, and pays to purchase, the operation server or the virtual SIM card operation server bundles the order information of the subscriber with the IMSI resources.

The roaming package information may comprise information like applicable country, supported card type of MODEM port module, cell phone design type, data capacity, session length, and package fees.

IMSI is an identifier used to differentiate mobile subscribers, which is typically stored in a real SIM card. In a virtual SIM card system, however, the IMSI information can be stored in a memory card of a cell phone. IMSI consists of three parts: MCC, MNC and MSIN. MCC is the code of a country where a mobile subscriber belongs to, MNC is a mobile network code, and MSIN is mobile subscriber identification number. Each subscriber has a unique IMSI code.

The step S2 may further comprise: when a subscriber is ready to use the roaming package, the subscriber can enter an activation page on the mobile terminal APP for activation. When the subscriber activates the order through the mobile terminal APP, the operator or the virtual operator can write IMSI and authentication data corresponding to the order information into the activated virtual SIM card in the subscriber mobile terminal. When activation is performed, the subscriber can select a specific card slot applicable to the mobile terminal for activation.

The real SIM card in the cell phone terminal may be used in coordination with the virtual SIM card. When the virtual SIM card is not activated, the real SIM card can work normally; after the virtual SIM card is activated, the use priority of the virtual SIM card may be higher than the priority of the real SIM card. At this moment, a SIM card for normal operations may need to be selected according to the type of cell phone design and the card type of the MODEM port module. In such a way, the method can ensure that the virtual SIM card is not affected by the real SIM card in use. Provided that the normal operations of the virtual SIM card are ensured, a Modem card slot or cell phone card slot, if vacant, may be assigned for a real SIM card to use.

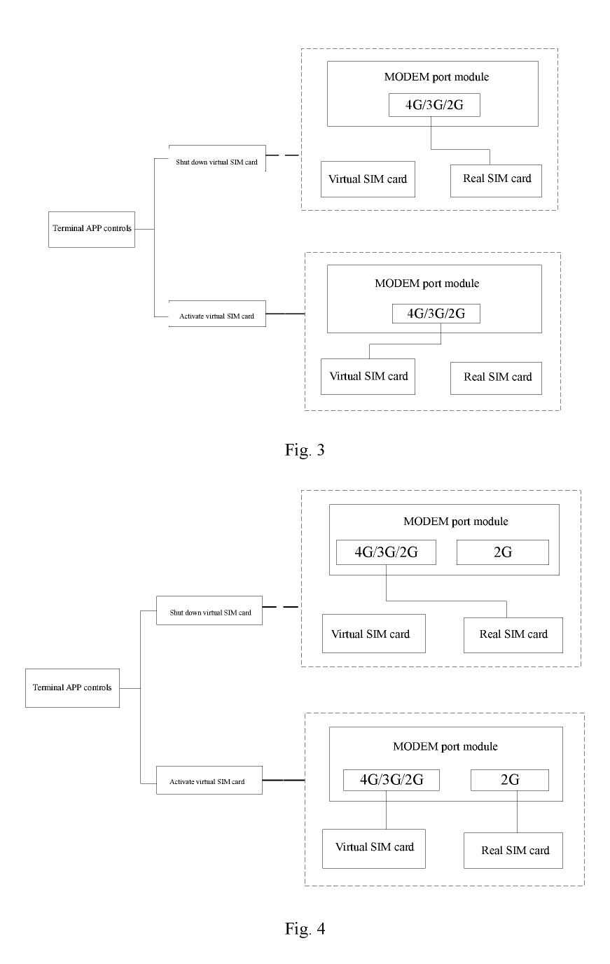

As shown in FIGS. 3-5, there can be two card types of a MODEM port module, single card and dual card; similarly, the cell phone design supports two types, single card and dual card. The card type of the MODEM port module and the type of cell phone design can be paired up in any way, and a subscriber may make an appropriate selection according to his/her own cell phone. Analysis will be provided for different combinations:

As shown in FIG. 3, when a modem supports a single card and a cell phone design is also single card:

when the virtual SIM card is not activated, the port of the MODEM port module can be connected to a real SIM card, and the real SIM card is in a normal working state; when the virtual SIM card is activated, the only port of the MODEM port module is connected to the virtual SIM card, and all other real SIM cards are in an invalid state.

As shown in FIG. 4, when the modem supports dual cards and the cell phone design is single card:

when the virtual SIM card is not activated, one of the ports of the MODEM port module is connected to a real SIM card, and the real SIM card is in a normal working state; when the virtual SIM card is activated, the two ports of the MODEM port module are connected to the real SIM card and the virtual SIM card, the real SIM may still be in a normal working state, and the virtual SIM card can enter a normal working state. At this moment, the cell phone is equivalent to dual card dual standby.

When the activated state of the virtual SIM card is shut down, the real SIM card is in a normal working state, and the virtual SIM card exits the normal working state.

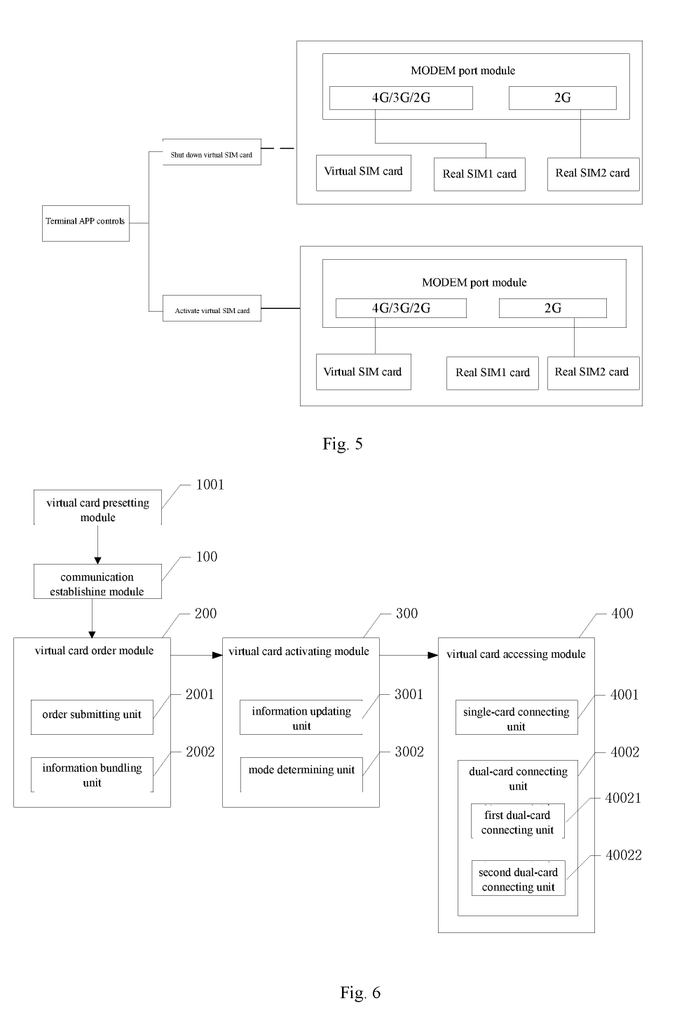

As shown in FIG. 5, when the modem supports dual cards and cell phone design includes dual cards:

when the virtual SIM card is not activated, the real cards SIM1 and SIM2 connected to two ports of the MODEM port module, are in a normal working state; when the virtual SIM card is activated, one of the card slots is selected to activate the virtual SIM card, and then the virtual SIM card enters a normal working state. The real card SIM1 (or SIM2) in another card slot is still in the normal working state, while the real card SIM2 (or SIM1) in the card slot of the activated virtual SIM card becomes invalid. When the activated state of the virtual SIM card is shut down, the two real SIM cards recover to the normal working state, and the virtual SIM card exits the working state.

When the virtual SIM card connected to the MODEM port module works normally, the network of the operator is accessed according to IMSI and authentication data read from the virtual SIM card.

On the basis of the method above, the present invention further provides a system for implementing a virtual SIM card, as shown in FIG. 6, comprising:

a communication establishing module 100 configured to establish communication connection between a subscriber terminal and a virtual SIM card operation server;

a virtual card order module 200 configured for the virtual SIM card operation server to return to the subscriber terminal, according to the received order information of the subscriber terminal for purchasing a virtual SIM card, IMSI and authentication information of a virtual SIM card corresponding to the order information;

a virtual card activating module 300 configured for the subscriber terminal to download the IMSI and authentication information returned by the virtual SIM card operation server locally and activate a preset virtual SIM card module according to the IMSI and authentication information; and

a virtual card accessing module 400 configured to establish connection between the virtual SIM card module and a MODEM port module, and the MODEM port module accessing the network by reading the IMSI and authentication information in the virtual SIM card module.

The system can further comprise: a virtual card presetting module 1001 configured to create a virtual SIM card module in a memory of the subscriber terminal; said virtual SIM card module is configured to store the IMSI and authentication information downloaded from the virtual SIM card operation server.

The virtual card order module 200 can further comprise: an order submitting unit 2001 configured for the subscriber terminal to submit purchase orders of virtual SIM cards selected by the subscriber to the virtual SIM card operation server;

an information bundling unit 2002 configured for the virtual SIM card operation server to perform one-to-one bundling of the purchase orders and IMSIs of corresponding virtual SIM cards according to the received purchase orders. When a subscriber purchases a roaming package in the terminal APP, the virtual SIM card operation server completes a bundling relationship between the subscriber and the order, the MODEM port module can access the network according to the IMSI and authentication data corresponding to the bundling relationship, and each subscriber and order form a unique IMSI.

The virtual card activating module 300 can further comprise: an information updating unit 3001 configured for the subscriber terminal to update the SIM card information stored in the virtual SIM card module according to the IMSI and authentication information returned by the virtual SIM card operation server;

a mode determining unit 3002 configured to determine whether the SIM card activation mode supported by the MODEM port module is a single-card mode or a dual-card mode;

The virtual card accessing module 400 can further comprise: a single-card connecting unit 4001 configured to, when it is determined that the SIM card activation mode supported by the MODEM port module is a single-card mode and a signal to activate the virtual SIM card module is received, establish communication connection between the virtual SIM card module and the MODEM port module;

a dual-card connecting unit 4002 configured to, when it is determined that the SIM card activation mode supported by the MODEM port module is a dual-card mode and a signal to activate the virtual SIM card module is received, establish communication connection in which a valid real SIM card module and the virtual SIM card module are both connected to the MODEM port module.

In an embodiment, the type of the real SIM card module comprises single card type or dual card type, and the dual-card connecting unit 4002 further comprises:

a first dual-card connecting unit 40021 configured to, when the type of the real SIM card module is the single card type, control two ports of the MODEM port module to connect to the real SIM card module of the single card type and the virtual SIM card module;

a second dual-card connecting unit 40022 configured to, when the type of the real SIM card module is the dual card type, control two ports of the MODEM port module to connect to any real SIM card in the real SIM card module of the dual card type and the virtual SIM card module.

The first dual-card connecting unit 40021 is further configured to, upon receiving a signal to shut down the virtual SIM card module, control the real SIM card module of the single card type to maintain a normal working state and control the virtual SIM card module to exit the working state.

The second dual-card connecting unit 40022 is further configured to, upon receiving a signal to shut down the virtual SIM card module, control the real SIM card module of the single card type to maintain a normal working state and control the virtual SIM card module to exit the working state.

The SIM card module of a subscriber terminal comprises a real SIM card module and a virtual SIM card module; said virtual SIM card module implements functions of a hardware real SIM card module by means of software; the virtual SIM card module is further configured to, after an order is successfully activated, receive IMSI and corresponding authentication data sent by the virtual SIM card operation server to the virtual SIM card through the terminal APP; the virtual SIM card module and the real SIM card module are used in coordination according to the types of the MODEM port module and cell phone design. When the virtual SIM card module is activated, the priority of the virtual SIM card module is higher than the priority of the real SIM card module.

In an embodiment where the MODEM port module supports single card and cell phone design is single card, when the virtual SIM card module is in a closed state, the real SIM card module is in a normal working state; when the virtual SIM card module is activated, the real SIM card module is invalid;

In an embodiment where the MODEM port module supports dual cards and cell phone design is single card, when the virtual SIM card module is in a closed state, the real SIM card module is in a normal working state; when the virtual SIM card module is activated, the real SIM card module and the virtual SIM card module both work normally;

In an embodiment where the MODEM port module supports dual cards and cell phone design is dual cards, when the virtual SIM card module is in a closed state, the two real SIM card modules both work normally; when the virtual SIM card module is activated, the real SIM card module in the card slot of the activated virtual SIM card module becomes invalid, and the other real SIM card module and the virtual SIM card module both work normally.

The MODEM port module may further comprise an accessing module configured for the MODEM port module to, after the virtual SIM card module is activated, access the network through the IMSI and authentication data in the virtual SIM card module.

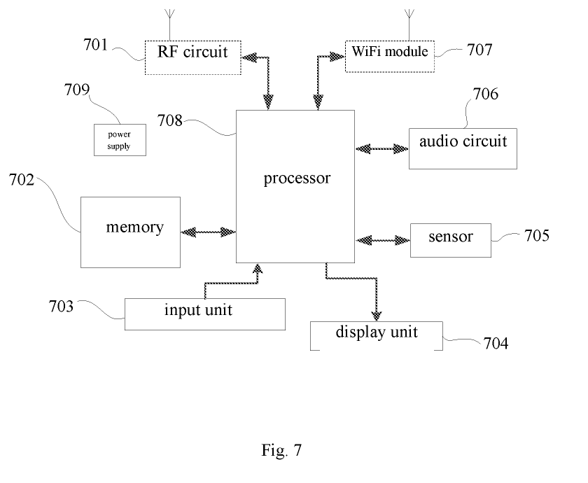

On the basis of the method above, the present invention further discloses a smart terminal for carrying out the above method for implementing a virtual SIM card and/or running the above system for implementing a virtual SIM card. The smart terminal or terminal device can be a cell phone or a tablet computer, or other smart wearable devices using SIM cards. As shown in FIG. 7, said terminal device may comprise:

A Radio Frequency (RF) circuit 701, a memory 702 comprising one or more computer readable storage media, an input unit 703, a display unit 704, a sensor 705, an audio circuit 706, a Wireless Fidelity (WiFi) module 707, a processor 708 comprising one or more processing cores, and a power supply 709. Those skilled in the art should understand that the terminal structure shown in FIG. 7 does not constitute a limitation to the terminal, which may comprise more or less parts than what are shown in the figure, or combine some parts, or have a different arrangement of parts.

In an embodiment, the processor 708 in the terminal can upload executable program codes corresponding to processes in one or more applications into the memory 702 according to corresponding instructions, and the processor 708 can run[[s]] the applications stored in the memory 402, thereby carrying out the above method for implementing a virtual SIM card or running the above system for implementing a virtual SIM card and then realizing various corresponding functions.

Reference can be made to the above method embodiment for specific operations mentioned above, which will not be repeated herein.

Those skilled in the art should understand that all or a part of the procedures in the method of the above embodiment may be implemented by relevant hardware as instructed by computer programs, and the computer programs may be stored in a computer readable storage medium. During execution, the programs may comprise flows of the above method embodiments. The storage medium therein may be magnetic disk, optical disk, Read Only Memory (ROM) or Random Access Memory (RAM). According to the present invention, a communication connection is established between a subscriber terminal and a virtual SIM card operation server. The virtual SIM card operation server can return to the subscriber terminal, according to the received order information of the subscriber terminal for purchasing a virtual SIM card, IMSI and authentication information of a virtual SIM card corresponding to the order information. The subscriber terminal can download the IMSI and authentication information returned by the virtual SIM card operation server locally, and can activate a preset virtual SIM card module according to the IMSI and authentication information. The virtual SIM card module can access the network via a MODEM port module. A subscriber can select different roaming packages according to the type of the SIM card in his/her own cell phone, and can conveniently access the Internet, which not only avoids the trouble to look for free WIFI or replace with a local SIM card, but also can avoid the high roaming expenses due to the use of a domestic network in other countries or a different location.

It should be understood that those skilled in the art can make equivalent substitutions or changes according to the technical solutions and invention concepts of the present invention, while all these substitutions or changes shall be encompassed by the appended claims.

1. A method for implementing a virtual SIM card, comprising:
establishing communication connection between a subscriber terminal and a virtual SIM card operation server;
returning to the subscriber terminal, by the virtual SIM card operation server according to a received order information of the subscriber terminal for purchasing the virtual SIM card, IMSI and authentication information of the virtual SIM card corresponding to the received order information;
the subscriber terminal downloading the IMSI and authentication information returned by the virtual SIM card operation server locally and activating a preset virtual SIM card module according to the IMSI and authentication information; and
establishing a connection between the virtual SIM card module and a MODEM port module, wherein the MODEM port module accesses the network by reading the IMSI and authentication information in the virtual SIM card module.

2. The method for implementing a virtual SIM card according to claim 1, wherein, before the establishing communication connection between a subscriber terminal and the virtual SIM card operation server, it further comprises:
creating a virtual SIM card module in a memory of the subscriber terminal, wherein said virtual SIM card module is configured to store the IMSI and authentication information returned from the virtual SIM card operation server.

3. The method for implementing a virtual SIM card according to claim 2, wherein the returning to the subscriber terminal, by the virtual SIM card operation server according to the received order information of the subscriber terminal for purchasing the virtual SIM card, IMSI and authentication information of the virtual SIM card corresponding to the order information further comprises:
the subscriber terminal submitting purchase orders of virtual SIM cards selected by the subscriber to the virtual SIM card operation server; and
the virtual SIM card operation server performing one-to-one bundling of the purchase orders and IMSIs of corresponding virtual SIM cards according to the purchase orders.

4. The method for implementing a virtual SIM card according to claim 2, wherein the activating the preset virtual SIM card module according to the IMSI and authentication information further comprises:
the subscriber terminal updating SIM card information stored in the virtual SIM card module according to the IMSI and authentication information returned by the virtual SIM card operation server.

5. The method for implementing a virtual SIM card according to claim 2, wherein the activating a preset virtual SIM card module according to the IMSI and authentication information further comprises:
determining whether a SIM card activation mode supported by the MODEM port module is a single-card mode or a dual-card mode.

6. The method for implementing a virtual SIM card according to claim 5, wherein the establishing connection between the virtual SIM card module and a MODEM port module comprises:
when it is determined that the SIM card activation mode supported by the MODEM port module is a single-card mode and a signal to activate the virtual SIM card module is received, establishing communication connection between the virtual SIM card module and the MODEM port module;
when it is determined that the SIM card activation mode supported by the MODEM port module is a dual-card mode and a signal to activate the virtual SIM card module is received, establishing communication connection in which a valid real SIM card module and the virtual SIM card module are both connected to the MODEM port module.

7. The method for implementing a virtual SIM card according to claim 6, wherein a type of the valid real SIM card module comprises a single card type and a dual card type and the “when it is determined that the SIM card activation mode supported by the MODEM port module is a dual-card mode and a signal to activate the virtual SIM card module is received, establishing communication connection in which a valid real SIM card module and the virtual SIM card module are both connected to the MODEM port module” comprises:
when the type of the valid real SIM card module is the single card type, controlling two ports of the MODEM port module to connect to the valid real SIM card module of the single card type and the virtual SIM card module, respectively;
when the type of the real SIM card module is the dual card type, controlling two ports of the MODEM port module to connect to any real SIM card in the real SIM card module of the dual card type and the virtual SIM card module, respectively.

8. The method for implementing a virtual SIM card according to claim 7, wherein, after controlling two ports of the MODEM port module to connect to the valid real SIM card module of the single card type and the virtual SIM card module, respectively, the method further comprises:
upon receiving a signal to shut down the virtual SIM card module, controlling the valid real SIM card module of the single card type to maintain a normal working state and controlling the virtual SIM card module to exit the normal working state.

9. The method for implementing a virtual SIM card according to claim 7, wherein, after controlling two ports of the MODEM port module to connect to any real SIM card in the valid real SIM card module of the dual card type and the virtual SIM card module, respectively, the method further comprises:
upon receiving a signal to shut down the virtual SIM card module, controlling all real SIM cards in the valid real SIM card module of the dual card type to recover to a normal working state and controlling the virtual SIM card module to exit the working state.

10. The method for implementing a virtual SIM card according to claim 6, wherein a use priority of the virtual SIM card module is higher than a use priority of the valid real SIM card module.

11. A system for implementing a virtual SIM card, comprising:
a communication establishing processor module configured to establish communication connection between a subscriber terminal and a virtual SIM card operation server;
a virtual card order module configured for the virtual SIM card operation server to return to the subscriber terminal, according to a received order information of the subscriber terminal for purchasing a virtual SIM card, IMSI and authentication information of a virtual SIM card corresponding to the order information;
the virtual card activating module configured for the subscriber terminal to download the IMSI and authentication information returned by the virtual SIM card operation server locally and activate a preset virtual SIM card module according to the IMSI and authentication information; and
the virtual card accessing module configured to establish connection between the virtual SIM card module and a MODEM port module, wherein the MODEM port module accesses a network by reading the IMSI and authentication information in the virtual SIM card module.

12. The system for implementing a virtual SIM card according to claim 11, wherein the system further comprises:
the virtual card presetting module configured to create another virtual SIM card module in a memory of the subscriber terminal, wherein said another virtual SIM card module is configured to store the IMSI and authentication information downloaded from the virtual SIM card operation server.

13. The system for implementing a virtual SIM card according to claim 12, wherein the virtual card order module further comprises:
an order submitting unit configured for the subscriber terminal to submit purchase orders of virtual SIM cards selected by the subscriber to the virtual SIM card operation server; and
an information bundling unit configured for the virtual SIM card operation server to perform one-to-one bundling of the purchase orders and IMSIs of corresponding virtual SIM cards according to the purchase orders.

14. The system for implementing a virtual SIM card according to claim 12, wherein the virtual SIM card activating module further comprises:
an information updating unit configured for the subscriber terminal to update the SIM card information stored in the virtual SIM card module according to the IMSI and authentication information returned by the virtual SIM card operation server.

15. The system for implementing a virtual SIM card according to claim 12, wherein the virtual SIM card activating module further comprises: a mode determining unit configured to determine whether a SIM card activation mode supported by the MODEM port module is a single-card mode or a dual-card mode.

16. The system for implementing a virtual SIM card according to claim 15, wherein the virtual SIM card accessing module further comprises:
a single-card connecting unit configured to, when it is determined that the SIM card activation mode supported by the MODEM port module is a single-card mode and a signal to activate the virtual SIM card module is received, establish communication connection between the virtual SIM card module and the MODEM port module;
a dual-card connecting unit configured to, when it is determined that the SIM card activation mode supported by the MODEM port module is a dual-card mode and a signal to activate the virtual SIM card module is received, establish communication connection in which a valid real SIM card module and the virtual SIM card module are both connected to the MODEM port module.

17. The system for implementing a virtual SIM card according to claim 15, wherein a type of the real SIM card module comprises a single card type and a dual card type and the dual-card connecting unit further comprises:
a first dual-card connecting unit configured to, when the type of the real SIM card module is the single card type, control two ports of the MODEM port module to connect to the real SIM card module of the single card type and the virtual SIM card module, respectively;
a second dual-card connecting unit configured to, when the type of the real SIM card module is the dual card type, control two ports of the MODEM port module to connect to any real SIM card in the real SIM card module of the dual card type and the virtual SIM card module, respectively.

18. The system for implementing a virtual SIM card according to claim 17, wherein:
the first dual-card connecting unit is further configured to, upon receiving a signal to shut down the virtual SIM card module, control the real SIM card module of the single card type to maintain a normal working state and control the virtual SIM card module to exit the normal working state;
the second dual-card connecting unit is further configured to, upon receiving a signal to shut down the virtual SIM card module, control the real SIM card module of the single card type to maintain the normal working state and control the virtual SIM card module to exit the normal working state.

19. A smart terminal, comprising:
one or more processors;
a memory, and
one or more programs, wherein said one or more programs are stored in the memory and configured to be executed by said one or more processors, said one or more processors are configured to execute the following instructions: establishing communication connection between a subscriber terminal and a virtual SIM card operation server;
returning to the subscriber terminal, by the virtual SIM card operation server according to a received order information of the subscriber terminal for purchasing a virtual SIM card, IMSI and authentication information of a virtual SIM card corresponding to the received order information;
the subscriber terminal downloading the IMSI and authentication information returned by the virtual SIM card operation server locally and activating a preset virtual SIM card module according to the IMSI and authentication information; and
establishing connection between the virtual SIM card and a MODEM port module, wherein the MODEM port module accesses a network by reading the IMSI and authentication information in the virtual SIM card module.

20. The smart terminal according to claim 19, wherein, before being configured to establish communication connection between a subscriber terminal and the virtual SIM card operation server, said one or more processors are further configured to execute the following instructions:
creating another virtual SIM card module in the memory of the subscriber terminal, wherein said another virtual SIM card module is configured to store IMSI and authentication information downloaded from the virtual SIM card operation server.
